(19) United States
(12) Patent Application Publication
(10) Pub. No.: US 2017/0285665 A1
(43) Pub. Date: Oct. 5, 2017

(54) METHOD, APPARATUS, AND SYSTEM FOR WATER MANAGEMENT

(71) Applicant: e.Digital Corporation, San Diego, CA (US)

(72) Inventors: Patrick O'Neal Nunally, Escondido, CA (US); Kevin Bostenero, Poway, CA (US); Alfred Falk, Fallbrook, CA (US)

(21) Appl. No.: 15/085,688

(22) Filed: Mar. 30, 2016

(51) Int. Cl. G05D 7/06; G01M 3/02; G01F 1/66

(52) U.S. Cl. CPC G05D 7/0635; G01F 1/66; G01M 3/02

(57) ABSTRACT

The disclosed embodiments describe a method, apparatus, and system for water management. At least one smart aquameter may be used to connect to a plumbed water system. The smart aquameter may measure a variety of sensor data, process, analyze, store, report, or control information related to the water system. The acoustic, pressure, and temperature characteristics of water in a plumbed system, amongst other things, may be used to identify which outlet is using water, for how long, and how much. This information, along with other relevant information, may be utilized to report, alert, optimize, inform, educate, and regulate the water system, for consumers, utility companies, and resource agencies.

### I. FIELD

The disclosed embodiments relate to methods, apparatuses, and systems for water management. Specifically, they relate to plumbed fluid systems.

### II. BACKGROUND

Water is a precious resource with less than 1% of it being available for human use. Conservation is more important than in the past, because of population increases, chronic waste problems, and record droughts. Resource agencies make some efforts to educate the public about using water more efficiently. For example, to fix commercial and residential water leaks. However, often leaks go undetected unless the symptoms are really obvious. Some consumers may not understand how much water they are wasting. For example, the average home may leak more than 10,000 gallons of water every year. Consumers may receive notice of their total water usage, but may not know how much of that is attributed to inefficiencies. Moreover, water rates are increasing, especially in low resource areas. Consumers may want to reduce their water expenses by being more efficient. Therefore, there is a need in the art to provide consumers, both commercial and residential, with accurate information and control for water management.

### SUMMARY

Methods, apparatuses, and systems for water management are described. In an embodiment, a smart aquameter, for water management is described, comprising: a power module adapted to power the smart aquameter; an input-output module adapted to intake water from a plumbed system; a sensor module adapted to measure water characteristics; a communication module; a processor module adapted to send information based on the measured water characteristics via the communication module; and a memory module coupled to the processor module.

In yet another embodiment, a smart aquameter, for water management is described, comprising: a power module adapted to power the smart aquameter; an input-output module comprising a sensor module; a sensor module adapted to measure plumbed system characteristics, the sensor module comprising a microphone; a communication module; a processor module adapted to analyze the acoustic characteristics the plumbed system, adapted to send information based on the measured plumbed system characteristics using the communication module; and a memory module coupled to the processor module.

In another embodiment, a method for water management is described, comprising: measuring acoustics of a plumbed water system; processing the measured acoustics to generate acoustic patterns; identifying at least one water outlet based on the generated acoustic patterns; reporting the plumbed water system characteristics, the characteristics comprising the identified at least one water outlet.

### BRIEF DESCRIPTION OF THE DRAWINGS

The following embodiments may be better understood by referring to the following figures. The figures are presented for illustration purposes only, and may not be drawn to scale or show every feature, orientation, or detail of the embodiments. They are simplified to help one of skill in the art understand the embodiments readily, and should not be considered limiting.

FIG. 1. illustrates a basic smart aquameter system in an embodiment(s).

FIG. 2. illustrates a basic smart aquameter in an embodiment(s).

FIG. 3. illustrates a basic smart aquameter system used in a residential home in an embodiment(s).

FIG. 4A. illustrates a simplified diagram of water pressure over time in an embodiment(s).

FIG. 4B. illustrates a simplified example of audio produced by the pipe vibrations when water is turned on and off in an embodiment(s).

FIG. 5A. illustrates one way a smart aquameter may connect to the pipes in an embodiment(s).

FIG. 5B. illustrates another way a smart aquameter may connect to the pipes in an embodiment(s).

FIG. 5C. illustrates yet another way a smart aquameter may connect to the pipes in an embodiment(s).

FIG. 6. illustrates a water management flow chart in an embodiment(s).

FIG. 7. illustrates a water management process(es) in an embodiment(s).

FIG. 8. illustrates a water management process 800 in an embodiment(s).

### DETAILED DESCRIPTION

Each of the additional features and teachings disclosed below can be utilized separately or in conjunction with other features and teachings to provide a method, apparatus, and system for water management. Representative examples of the following embodiments, will now be described in further detail with reference to the attached drawings. This detailed description is merely intended to teach a person of skill in the art details for practicing the preferred aspects of the teachings and is not intended to limit the scope of the embodiments.

The disclosed embodiments describe water management methods, apparatuses, and systems. However, the disclosed embodiments may be used with any plumbed fluids and not just water. The disclosed embodiments accomplish plumbed fluid: monitoring, optimization, integrity, control, reporting, quality supervision, and operation.

The disclosed embodiments may monitor the water through the use of at least one smart aquameter. For example, a smart aquameter may measure sensor information to determine which water outlet is used. The embodiments may help with the integrity of the system by providing detailed information to consumers, service providers, or resource regulators based on the monitoring. For example, the monitoring may indicate an upstairs toilet has a non-destructive leak, and that information may be communicated to the consumer, service provider, or resource agency informing them of the leak, so that it may be repaired.

The disclosed embodiments may help optimize the system by monitoring and determining, for example, that the dishwasher being used has a higher water usage rate than others. In this example, the consumer may replace the inefficient dishwasher with a more efficient appliance or change their operation habits of the appliance. The embodiments may control the system, for example, the monitoring may reveal that a destructive leak is occurring and no one is home to shut off the water valve. In this example, a relevant water valve may be shut off in response to the situation.

The disclosed embodiments may provide reporting of the water management. For example, a detailed report may be provided to the consumer that addresses water usages per specific outlets (e.g. faucets, appliances), times, uses or by specific user. The embodiments may provide supervision of water quality and in response report that information to a consumer or resource agency. For example, the water management embodiments may determine water quality or that there are dangerous levels of chemicals or bacteria in the water and take appropriate actions.

Moreover, the disclosed embodiments may allow for operation of the fluid management. For example, the smart aquameter may be upgraded with software, powered down, or have consumer preferences set. These are just some brief examples of functionality and scope of the water management methods, apparatus, and systems. The water management embodiments may be comprehensive such as a full system, or comprise some of the functions and components, as well as just the individual devices, like the smart aquameters, and all configurations are envisioned and within the scope of the disclosure.

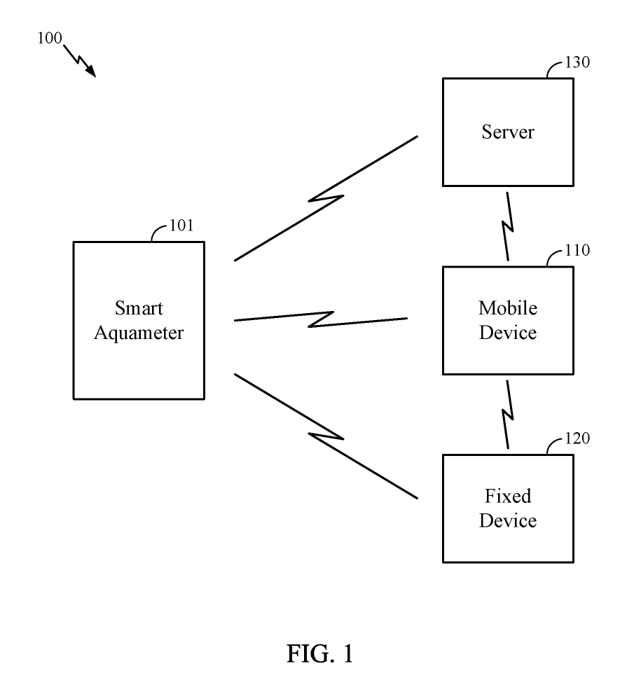

FIG. 1 illustrates a basic smart aquameter system 100 in an embodiment. System 100 comprises at least one smart aquameter 101. Smart aquameter 101 may communicate wirelessly or wired with server 130. Server 130 may be a remote server or a local server. Smart aquameter 101 may communicate wirelessly or wired with a mobile device 110. Mobile devices, such as 110, may include, but are not limited to the following: cell phone, mobile phone, tablet, laptop, computer, handheld radio, PDA, smart phone, e-reader, personal wearable device, or any suitable portable user device. Smart aquameter 101 may communicate wirelessly or wired with a fixed device 120. Fixed devices, such as 120, may include, but are not limited to the following: desk top computer, water sprinkler/irrigation timing box, valve, meter, or any suitable non-portable device. Likewise server 130 may communicate wirelessly or wired with either, or both, Mobile device 110 and fixed device 120. Likewise Mobile device 110 may communicate wirelessly or wired with either, or both, Server 130 and fixed device 120. Likewise Fixed device 120 may communicate wirelessly or wired with either, or both, Mobile device 110 and server 130. For example, smart aquameter 101 may measure, process, and report findings to server 130. Server 130 may be a third party server. For example, a utility provider. Server 130 may send alerts or specialized reports to Mobile device 110. Mobile device 110, may then send a control signal to fixed device 120. Fixed device 120, may send a confirmation signal to smart aquameter 101 and Mobile device 110. Smart aquameter 101 may transmit control signals to fixed device 120. Fixed device may send reports or alerts to Mobile device 110 in return. As one of skill in the art will readily recognize, the flexibility of a basic smart aquameter system 100 is desirable and may be configured for optimization of the desired goals and applications.

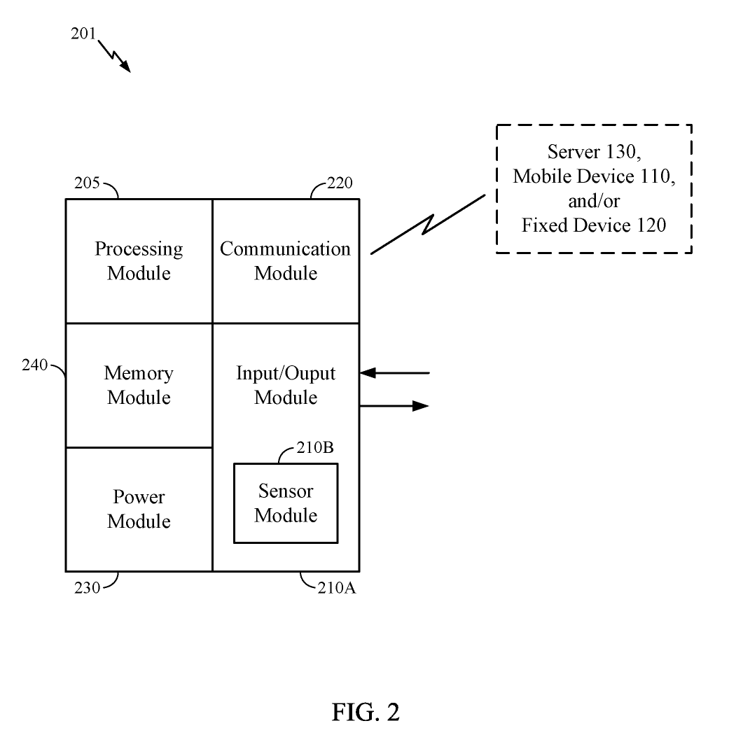

FIG. 2 illustrates a basic smart aquameter 201 in an embodiment. Smart aquameter 201 may comprise a Processing module 205 in an embodiment. Processing module 205 may comprise one or more processors. For example, processor module may comprise a digital signal processor (DSP) and a microprocessor. For example, Processor module 205 may comprise an analog to digital (ADC) convertor. Processing module 205 may control the various modules of the smart aquameter. Processing module may control the power, storing, measuring, processing, receiving, transmitting, and reporting of information as is well understood in the art. Processing Module 205 may supervise the receive and transmit functions of Communication module 220.

In an embodiment, Communication module 220 may comprise one or more transceivers and related circuitry to enable wired or wireless communication. For example, communication module 220 may comprise transceivers and related circuitry to communicate via Blutooth®, WiFi, CDMA, GSM, 3G, 4G, WAN, WLAN, PAN, LTE, UMTS, TDMA, FM, AM, MIMO, OFDM, all of which are well known in the art. Other communication schemes that may pass information between the two devices wirelessly may also be used. Examples of wired communications may be for example, RS232 and USB, both of which are well known in the art. Communication module 220 may comprise RF antennas, modems, mixers, amplifiers, filters, radios, encoders, coders, modulators, convertors, demodulators, baseband processors, or any components or circuitry required for wireless or wired communication as is well understood in the art. In an embodiment, Communication module 220 comprises WiFi, cellular, and USB communication capability.

Smart aquameter 201 may comprise Memory module 240 in an embodiment. Memory Module 240, in an embodiment, may comprise one or more memories. For example, memory module 240 may comprise RAM, ROM, Flash, or any combinations thereof. The memory may be included on one single “chip” or multiple “chips” as is well understood in the art. In an embodiment, Memory module 240 may comprise a disc, drive, or other forms of storage as is available in the art now or in the future.

Smart aquameter 201 may comprise a Power module 230 in an embodiment. Power module 230, in an embodiment, may comprise a connector, filtering, conversion, conditioning, etc. for a power source. For example, for an AC power source, a DC power source, or any combinations thereof. Power module 230 may also comprise a battery power source, a capacitor, or induction bank. For example, smart aquameter 201 may use power from an AC electrical outlet and have an internal capacitor bank. If the power goes out, the capacitor bank may provide enough power to finish saving to memory or transmitting information before the smart aquameter looses all power. In an embodiment, Power module 230 is adapted to receive power from an AC power source, and comprises a backup battery.

Smart aquameter 201 may comprise an Input/Output (I/O) module 210A in an embodiment. I/O module 210A, in an embodiment, may be further subdivided into Sensor module 210B. I/O module 210A may receive and/or send water (fluid intake and outtake). Any connectors that may be required are considered part of the I/O module 210A. For example, standard plumbing connectors as used in the industry, or ports/connectors that USB plug or power adapter, would need to plug into. Custom connectors may also be used for Input/Output module 210A. I/O module 210A may also receive and send various sensor information. Various sensors may be internal to the smart aquameter, external, or any combination thereof. A sensor may include any device or mechanism capable of detecting, measuring, transducing, or recording some physical attribute. Sensors that may be used, but not inclusively listed are: chemical, detectors, motion, microphones, speakers, cameras, optical, location, accelerometers, angle, audio, biometric, physiological, respiratory, capacitance, density, displacement, distance, electric current, electric potential, energy, force, gravity, gyroscopic, infrared, heart rate, humidity, imaging, level, linear acceleration, light, moisture, magnetic field, navigation, ranging, orientation, photon, position, presence, radiation, radio, speed, thermal, pressure, vector rotation, proximity, voice, speech patterns, phoneme, subatomic particles, temperature, user input, ultrasound, ultraviolet, ultra wideband, usage, vibration, video, or any combination therein. Some sensors may need to be in physical contact with water. The various sensors may be used to measure the water system attributes such as temperature, vibration, movement, pressure, quality, and content as well as infrastructure integrity and water usage.

Smart aquameter 201 may be used with water, oil, hydraulic fluids, or any fluids that may create differences in pressure, audio, temperature, etc. that may be used to characterize their plumbed fluid system.

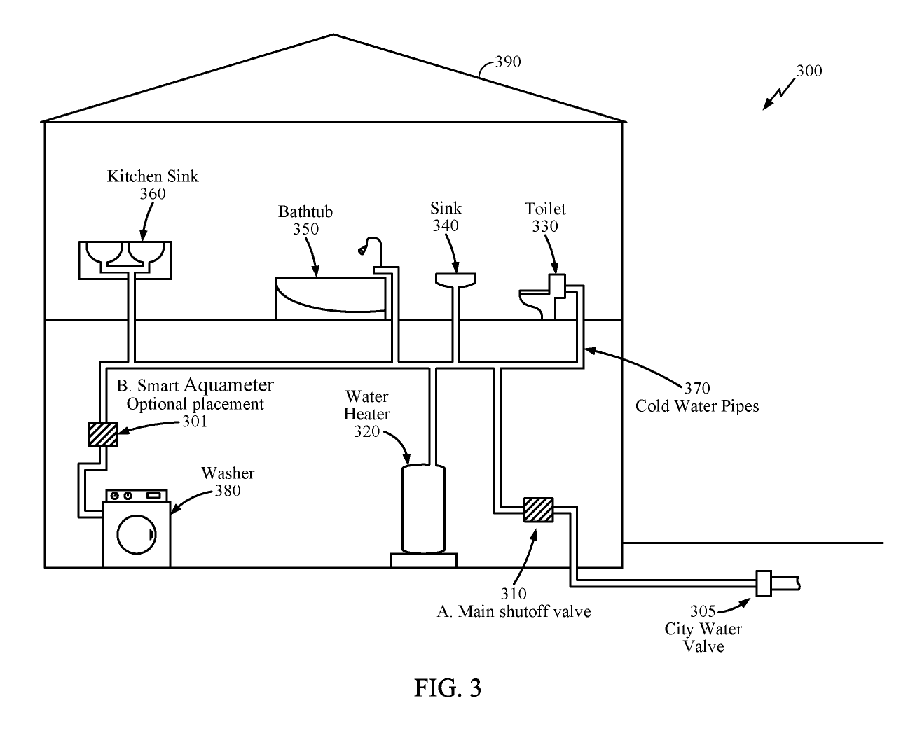

FIG. 3 illustrates a basic smart aquameter system 300 used in a residential home 390 in an embodiment. FIG. 3 uses a residential home for illustration, but a commercial building, a factory, a school, a restaurant, a hospital, a cruise ship, a hotel, a water park, an amusement park, an apartment building, or any structure that has plumbed water (or fluid) may utilize the described embodiments. This is an over simplified illustration with only a few outlets and only cold water pipes are illustrated for simplicity of explanation.

In FIG. 3, water is shown coming into home 390 from the city at the city water valve 305. Typical pressures of the city water are between 50-70 psi. The pressures may vary through out the day, weeks, months, etc. In other words, the pressure isn't constant. Usually, there is a main water shut off valve 310 shown as point “A” going into the home plumbing system. From there the water may travel throughout the house in cold water pipes 370 to various outlets: toilet 330, bathroom sink 340, bathtub 350, kitchen sink 360, washer 380, and hot water heater 320. In an embodiment, smart aquameter 301 is placed close to the washer machine 380 spout (faucet, valve, or spigot) shown as point “B.” Point B is a convenient place to place a smart aquameter, because the water lines are easily acceptable and there is typically available an AC power outlet. However, the smart aquameter may be placed in many locations throughout the plumbed system. For example, a smart aquameter may be placed near the hot water heater 320 intake, or at some point in the plumbed system. In conjunction, more than one smart aquameter may be used. For example, a large building with many floors may require smart aquameters placed strategically through out the building. Moreover, a smart aquameter may be placed on the hot water line as well as the cold water line.

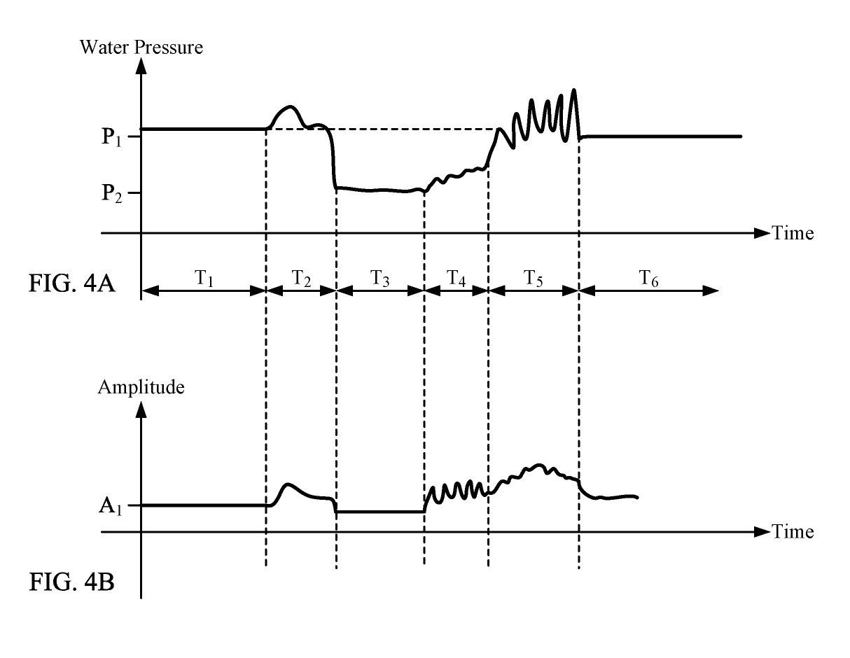

FIG. 4A illustrates a simplified diagram of water pressure over time as used in FIG. 3 residential home 390 in an embodiment. At time T₁, when none of the faucets are being used (assume for ease of explanation) a starting pressure level P1 is present in the pipes 370. At time T₂ when a faucet or valve is open, for example, at kitchen sink 360, the sudden change in velocity (movement of water) may cause the pressure to temporality increase or transition. This is called dynamic pressure. At time T₃ the water pressure stabilizes to the new level P2 that illustrates the drop in pressure do to the spout being turned on. At time T₄, the water spout is turned off and the sudden stop of flow of the water may cause a hydraulic surge, a pressure surge, a fluid transient, or what is commonly termed a “water hammer.” T₄ illustrates what a smaller water hammer may look like, but the water hammer may be larger and more pronounced as shown at time T₅. At time T₆, eventually the water pressure stabilizes and is back at the starting pressure P1.

In an embodiment, the water pressure deltas, or differentials, may be used to determine valve open and close times. In addition, the water pressure deltas may be used to determine which specific outlet was turned on and off. A single outlet's identity as well as its usage characteristics may be determined. The specific apparatus that is turned on or off may have a unique pressure over time characteristic. For example, the washer 380 may have a unique pressure drop and increase over time pattern that may enable one to determine its using water and not the bathtub 350.

In an embodiment, when two or more outlets are turned on in a staggered fashion, it may be possible to determine the individual identity and usage characteristics still, because of the staggered pressure differences in time. In other words, if the kitchen sink 360 was turned on for a few seconds, then later the bathtub 350 was turned on, then the kitchen sink 360 was turned off, but the bathtub was still on, the pattern of pressure differences over time may be used to separate out from the aggregate data the individual outlet characteristics.

In an embodiment, if the kitchen sink 360 and bathtub 350 were turned on at the same time, the cumulative pressure deltas and time transitions may be used to indicate how many or what spouts are open and closed in residential home 390. For example, the kitchen sink 360 and bathtub 350 may already have known characteristics. Once characteristics (or characterizations) are known they may be stored and utilized later. For example, the individual kitchen sink 360 outlet characteristic may be extracted out from the aggregate, to reveal the remaining known bathtub 350 characteristic. Moreover, because the pressure coming into the home from the city may vary through the day, it may be more important to focus on the pressure deltas than the actual pressure absolute values. Or the pressure amplitude may be normalized, post or pre-processing, and then the deltas compared etc. In addition, the layout of the pipes with varying lengths, turns (bends), etc. may effect the audio signal produced which may create unique audio patterns for the various faucets (water outlets). Thus, in an embodiment, in addition to pressure, acoustics may also be used to determine useful information. In an embodiment, acoustics may be used by itself to determine patterns in the water system, or pressure may be used, or both acoustics and pressure may be used.

FIG. 4B illustrates a simplified example of audio produced by the pipe vibrations when water is turned on and off. Vibrations in the plumbed system (connected pipes) may create audio waves. FIG. 4B is an example comparison in time of FIG. 4A. At time T₁, the audio amplitude being measured is A₁. A₁ may represent a noise floor for example. When the pressure variations start occurring at T₂, this may produce corresponding vibrations (acoustic waves) that may be measured. Moreover, a specific apparatus that turns on and off water may have unique acoustic patterns. For example, the toilet 330 may have a specific acoustic pattern (behavior or characteristic) when flushed. This information may be used to specify which device is using water. An acoustic sensor, e.g., a microphone and/or an accelerometer may be used to measure the vibrations of the pipes (or water). The acoustic sensor may be placed on the outside of the smart aquameter, close to the pipes, in contact with a pipe, or inside the smart aquameter. Moreover, other audio sounds may help identify the sources. For example, some appliances may whistle or ring when used such as when a valve on a toilet gets semi-clogged and whistles. Also, a water hammer may indicate which outlet is being used. A water hammer may produce ringing as low as, for example 5 Hz, or as high as 25 Khz. Frequency analysis or signal processing may be performed on the audio signals to provide information relevant to managing a water system. As with any of the measured, processed, or analyzed information, it may be stored in order to be used later on. Historical patterns over time may be created based on the stored patterns and information. For example, when the toilet 330 flushes, the acoustic signature of the flush may help determine how long the flush took (time), and at what pressures (pressure) which may help determine water usage. Audio may also be used to determine how much pressure there was, because the louder the pressure the louder the accompanying audio signal. In addition, both pressure and audio, individually or in combination, may help determine things such as if the toilet is upstairs or downstairs (identity).

Other information may be used to help determine patterns of usage over time. For example, historical information, inferences, and user specific information. Other information may be sent or received to and from smart aquameter 101. In an embodiment, the times of day of faucet use may be used to help determine patterns. The frequency of spout use may be used to help determine patterns. The amount of hot water v. cold water used may be used to help determine patterns. The proximity in time and/or distance of outlets used may be used to help determine patterns. For example, when a toilet is flushed a specific individual may use one side of a double sink consistently to wash their hands. Another example, of proximity may be knowing that a kitchen sink used prior to a dishwasher starting can be inferred to be associated with cleaning dishes in preparation for the cycle. The timing of the uses may be used to help determine patterns, for example, knowing that a person is washing their hands in a identifiable manner: e.g. a person turns on hot water, but doesn't wait for it to get hot, or brushes their teeth in cold water for a certain time period. In addition, specific activities may be used to help determine patterns, for example, parties may cause the ice maker to run constantly and the sprinklers to be shut off. In another example, yard work may cause a shower to move from typical morning times to afternoon. These are just some examples, many types information and logical inferences may be made in order to help determine patterns of usage over time.

In an embodiment, signal processing may be used to analyze the rate at which a vibration occurs which represents the use of water within a plumbed system. The vibrations in the plumbed system may be analyzed as a series of harmonically-related sinusoids with different amplitudes and phases. The amplitude and phase of a sinusoid may be combined into a single complex number, called a Fourier coefficient. The vibrations may be analyzed as periodic functions, or functions that are defined only over a finite-length length of time.

The audio and/or pressure produced may be effected by the stiffness of the pipes, the material the pipes are made of, the diameter of the pipes, the thickness of the pipe wall, the length of the pipes, and how many turns are in the path. Steel pipes, for example, may produce lower amplitudes of pressure or sound, because of the dampening effect the pipe will have on vibrations. While plastic pipes may have comparably higher amplitudes. The elasticity of the pipe walls will effect velocity. So if the pipes expand or contract with temperature, the diameter and/or elasticity of the pipes may change which will effect the calculations. Well known mathematical principals are available to process and analyze the information. The following standard two-equation model is used commonly for calculating the effect of water hammer:

$$\frac{dV}{dt} + \frac{1 dP}{{ρ}_{f} dz} = 0 , \\ \frac{dV}{dz} + \frac{1 dP}{{ρ}_{f} {c}_{f}^{2} dt} = 0 , \qquad Equation 1$$

Where d denotes partial derivitve, P is pressure, V is velocity, ρ_{f} is the mass density of the fluid, c_{f} is the velocity of sound in the fluid, t is time, and z is the distance along the pipe.

A “water hammer” is basically pressure surges caused when a fluid in motion is forced to stop or change direction suddenly. The use of well known fluid-structure interactions may be used to process or analyze the information. For example, friction coupling, junction coupling, and Poisson coupling may be useful to analyze. Although, ideally, the disclosed embodiments may be used with any fluid that is plumbed (flows through connected pipes or hoses), fluids with more mass density will create a more measurable water hammer and pressure differences. The vibrations from the waves in the fluid, the pipe walls, and the radial vibrations of the system may all contribute to the information that may be measured and used to determine patterns. Flow noises are another example of acoustics that may help characterize a plumbed system.

Flow noises may be caused in flows through pipes by turbulent flow where a proportion of the flow energy is converted into sound energy. This is especially true when flow is quickly halted such as when a faucet is shut off. In plumbed systems, flow noise is usually of subordinate magnitude and highly dependent on the system implementation (size, length, angles, fittings, etc.) The attenuation of flow noise may be calculated as:

$${D}_{E} = {R}_{R} - 10 log ( \frac{4}{10 {D}^{- 3}} ) - 10 log ( \frac{sinh ( β )}{B } ) + Δ L \\ Where \text{:} \\ {R}_{R} = 10 + 10 log [ ( \frac{{c}_{w} \cdot {ρ}_{w} \cdot s}{{c}_{F} \cdot {ρ}_{F} \cdot d} ) ] - 10 log [ 3 ( \frac{{f}_{r} / 5}{f} ) + 5 ( \frac{f}{{f}_{r}} ) ] + {R}_{K} \\ {c}_{F} = ( \sqrt{\frac{1.4 \cdot p \cdot {10}^{5}}{{ρ}_{F}}} ) \\ {f}_{r} = \frac{{c}_{W}}{π \cdot d \cdot {10}^{- 3}} \\ {R}_{K} = - 35 \cdot log ( 1 + \frac{3}{[ {( \frac{f}{{f}_{g}} - \frac{1.5 \cdot {f}_{g}}{f} )}^{2} + 1 ]} ) \\ Where \\ {R}_{K} = 0 for {f}_{g} < {f}_{r} \\ {f}_{g} = 6.4 ( \frac{{10}^{4}}{{c}_{W} ( s \cdot {10}^{- 3} )} ) \\ B = \frac{1}{( d \cdot {10}^{- 3} )} \cdot [ \frac{2 \cdot {10}^{- 0.1 \cdot {R}_{g}}}{8.69} ] \\ α = \frac{4.9 \cdot {10}^{- 4}}{d \cdot {10}^{- 3}} \cdot \sqrt{\frac{f}{p}} \cdot {( \frac{273 + t}{293} )}^{0.25} \cdot ( 1 + 11 \cdot {M}_{A} ) \\ Where \\ {M}_{A} = v / {c}_{F} \\ Δ L = 0.5 \cdot ( 17.37 \cdot \frac{1}{d \cdot {10}^{- 3}} ) \cdot {10}^{- 0.1 \cdot {R}_{R}} + α \qquad Equation 2$$

Where:
L=section length in meters [m]
d=pipe diameter in [mm]
v=flow speed in the pipe [m/s]
p=pressure in the pipe [bar(abs)]
ρ_{F}=fluid density in the pipe [kg/m3]
t=temperature in the pipe [grd C]
s=pipe wall thickness [mm]
ρ_{w}=pipe wall density [kg/m3]
c_{W}=expanding wave speed of the pipe material [m/s]

In an embodiment, water flowing primarily through a given subset of plumbed pipes as well as pressure effects give rise (as shown above) to vibrational responses of the plumbed system. Relative information regarding the flow of water and its path through the plumbed system may be hidden in finite or periodic vibrational responses of the plumbed system. While responses to individual flow within a plumbed system may be calculable the results may depend on minor variations of the systems structure and layout as well as its conditions and state of operation. In an embodiment, the vibration of the plumbed system may be used to characterize which faucet is in use rather than calculating the functional operators which contribute to the specific flow pattern. In an embodiment, the computational load and system accuracy may be enhanced by the application of signal processing of the vibration and pressure variations within the plumbed system.

In an embodiment, once the smart aquameter and/or sensors are used to gather information to determine water usage behaviors (patterns or characteristics), the information may be processed, analyzed, and used to create alerts, controls, reports and various other functions to achieve the goals of water management. In an embodiment, smart aquameter 101 may measure raw data and transmit the raw data to server 130, mobile device 110, or fixed device 120, or any combinations thereof. In an embodiment, smart aquameter 101 may measure raw data and process it and transmit the processed data to server 130, mobile device 110, or fixed device 120, or any combinations thereof. In an embodiment, smart aquameter 101 may measure the data and process and analyze the information and transmit analyzed information to server 130, mobile device 110, or fixed device 120, or any combinations thereof. Of course, in any embodiment, the information may be stored on the smart aquameter 101, server 130, mobile device 110, or fixed device 120, or any combinations thereof.

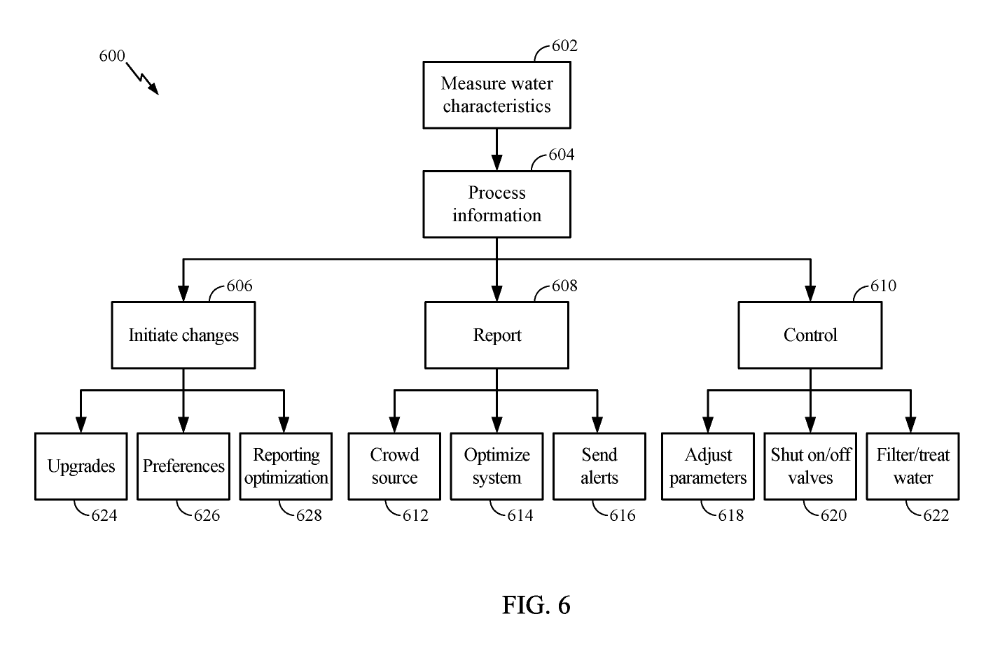

FIG. 6. illustrates a water management flow chart 600 in an embodiment(s). First, the plumbed system's water characteristics are measured 602. The measurements may be in response to a request from server 130, mobile device 110, fixed device 120, or smart aquameter 101. Or the system 100 may have programed scheduling in place that periodically measures, measures in response to events, in response to triggers, constantly measures, in response to a predetermined schedule, or any combinations thereof. As noted above, a smart aquameter 101 may accomplish this. It may measure pressure, audio, or additional information, or any combinations thereof. Smart aquameter 101 may receive information to process. Then, the information measured, transmitted, or received, is processed 604. The processing may be done at the smart aquameter 101, or the server 130, mobile device 110, fixed device 120, or any combinations thereof. The processing may include detailed analysis. For example, the processing may use some or all of the mathematical principals disclosed to identify and characterize the information. Well known methods of processing the information may become available, or are available, that are not described, but are included in the embodiments, because they are either well known in the art, or would be equivalent to the known and disclosed methods. After the information is processed, several functions are within the scope of the disclosed embodiments.

For example, the information may be reported 608 to the consumer, utility companies, resource agencies, or any entity that needs or desires the information. Reporting may be accomplished with the use of system 100. The reports may be basic, itemized, detailed, or any combinations thereof. In an embodiment, a report may be an alert 616 that informs a relevant entity that there is a leak, or problem with the monitored water system. For example, a report may be sent to a resource agency informing them that a leak at an apartment building has been leaking an amount over a threshold. In an embodiment, a threshold may be one in time and/or quantity of water used. The resource may send someone to repair the leak, and charge the usage violator a fine.

A report, or information, may be sent that helps optimize the supervised water system 614. For example, a report may be sent to the consumer showing how much water they use, per outlet. The consumer may decide to take shorter showers, water their garden less, or replace appliances with more efficient ones as a result. Another example, is a report may breakdown the individual usages per appliance, user, or function and report an itemized usage. For example, the report may breakdown how much water yards, or swimming pools, are using and how much it costs the consumer a month. In another example, fire sprinkling systems may require constant pressures to operate. The fire sprinklers may be monitored and if any of them falls below a threshold of acceptable pressure, it may be reported and corrected.

A report may be used to perform some crowdsourcing functions 612. For example, participating consumers may report their usages to a third party server and a cumulative report, averages, and community findings may be compiled into another new report. This crowdsourcing report may then be transmitted back to the consumer to mobile device 110. Another example of reporting, may be that a consumer is using a specific brand-model appliance, and the information may be reported to the manufacture. The manufacture may compare the consumer's information to theirs and determine if the appliance is functioning in compliance with manufacturing standards. Another example of crowdsourcing functions, is a resource agency may receive reports from consumers in their area. The resource agency may filter out private information and use the findings to create averages of residential and commercial findings. The resource agency may publish the findings publically on their website. In an embodiment, smart aquameter 101 and the information that is reported between smart aquameter 101, server 130, mobile device 110, or 120 may be encrypted or comprise security measures so that privacy is controlled, and hacking is reduced or eliminated.

In an embodiment, the processed information 604 may be used to initiate changes 606 such as upgrades, preference changes, or reporting optimizations to the smart aquameter 101 or applications running on mobile device 110, server 130, or fixed device 120. For example, a family may be on vacation and their water usage is low or nonexistent. However, their smart aquameter may have been set to monitor daily and report daily usages. Based on the information received, the system may make a decision to send commands to the smart aquameter 101 to set the monitoring and reporting to once a week. This may help save power resources. In another example, a utility provider may determine a new or more efficient way to analyze water usage patterns, and it may send a software upgrade to smart aquameter 101 that allows smart aquameter 101 to use the new analysis methods. Moreover, the information processed may be used to control 610 the water system.

For example, the information may reveal that a toxic level of lead is in the water. The water management system may control valves 620, for example, to shut off the main valve and turn off a hot water heater in a home. In another example, the water management system may filter or treat 622 the water in response to an event. For example, the processed information may indicate a harmful bacteria detected and inject a chemical into the water to maintain health safety levels. Another example of a control function, may be to adjust parameters 618 of the system. For example, the system may determine the pressure going into the home from the city is too high and adjust a system parameter, like a pressure valve at the main, in order to lower the pressure to an acceptable level.

Control signals may also be sent to smart appliances, like a refrigerator that has wireless communication capability, in response to the measured and or processed information. Control signals to hot water heaters or water softeners are other examples. In addition, the temperature may be monitored, and if it is determined that the pipes are likely to freeze solid, then controls may be sent to heat the pipes or turn off the main valve and open an outlet to drain the pipes so that they won't burst. The various functionality of a water management system shown broadly in FIG. 6 are not meant to be limiting, or inclusive, but are provided to show that the envisioned embodiments have flexibility in functionality and applications. In an embodiment, all of the functionality shown n FIG. 6 is enabled. In another embodiment, only the reporting functionality is enabled. In yet another embodiment, only the control and reporting functionality is enabled. In an embodiment, only the reporting and initiation of upgrades is enabled. In an embodiment, any combinations of the reporting, control, or initiation of changes are enabled.

In an embodiment, water quality may be measured by the water management system and proper actions performed in response. Smart aquameter 101 may comprise chemical sensors that are in contact with the water and may detect organic material. The chemical sensors, or water quality sensors, may be internal to a smart aquameter or external. The sensors, for example, may comprise an array of sensors that may measure multiple organic materials. The measured organic materials may reveal a chemical characteristic(s) or profile of the water. This information may be used as noted above in the various embodiments. For example, the water management system may determine that an unacceptable level of lead is in the water and send an alert to the consumer and utility company. Some materials that effect the quality of water may need different sensors to measure. For example, dissolved solids (e.g. inorganic salts), may require a sensor that measures the conductivity of the water. A higher water conductivity may indicate that there are less dissolved solids in the water. In addition, optic sensors may be used to measure several water quality aspects. For example, light emitted and reflected may be used to measure inorganic materials. Other biological sensors may detect parasites or bacteria. Not all biological material are harmful or cause animals to be sick. Sometimes people in areas get immune to their own biologic water profile, and the traveling to a new biological profile is what triggers the sickness. In an embodiment, the biological profile of a water system may be reported and published online. For example, a city may report their biological profile. A consumer traveling to the city may compare their own biologic profile to the cities to know if they may get ill drinking the city water.

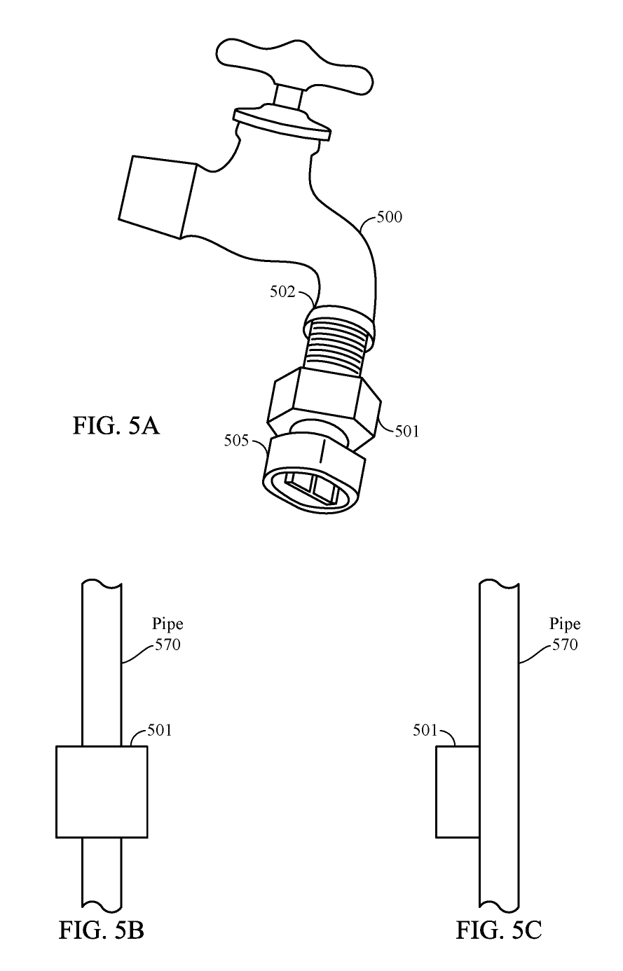

FIG. 5A. illustrates one way a smart aquameter may connect to the pipes in an embodiment(s). In an embodiment, smart aquameter 501 may be connected at a first end 502 to a spout 500. For example, a spout that supplies water to a washer machine. The washer machine hose may connect to a second end 505 of the smart aquameter 501 in order to receive water. Standard or custom male or female connectors used in the plumbing industries may be used at the first 502 and second 505 ends.

FIG. 5B. illustrates another way a smart aquameter may connect to the pipes in an embodiment(s). In an embodiment, smart aquameter 501 may be connected between or inline with pipes 570. Standard or custom male or female connectors used in the plumbing industries may be used to connect smart aquameter 501 between pipes 570. In yet another embodiment, smart aquameter 501 maybe shunted off to the side of pipe 510 as shown in FIG. 5C. Connectors described in FIG. 5A-5C may be included in Input/Output module 210A.

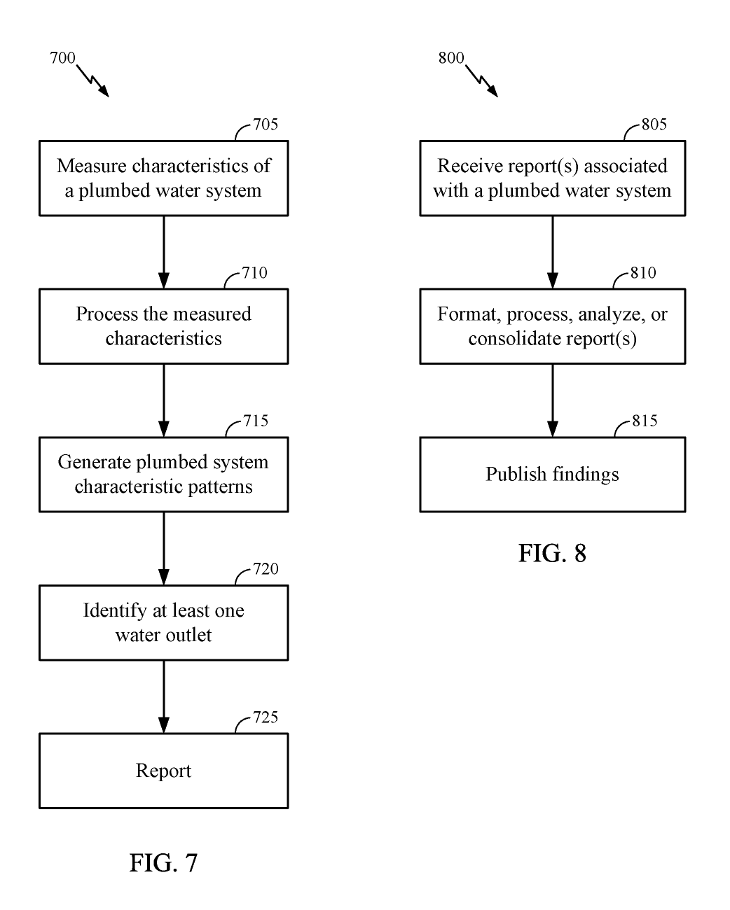

FIG. 7. illustrates a water management process 700 in an embodiment(s). At step 705, plumbed system characteristics are measured. In step 705 a water system is mentioned, but other fluids may be characterized. As described above, the acoustics, temperature, or pressure may be measured amongst other things. In an embodiment, at least one smart aquameter 101 may be used to measure the plumbed system characteristics. At step 710, the measured characteristics are processed. As mentioned, the processing may be done in whole or in part at the smart aquameter 101 or elsewhere. At step 715, plumbed system characteristics are generated. As mentioned, this may be done in whole or in part at the smart aquameter 101 or elsewhere. This may encompass, amongst other things, the inferences, history, and signal processing as described in the various embodiments. At step 720, at least one water outlet is identified based on the measured characteristics. For example, the kitchen sink may be identified as discussed for FIGS. 4A and 4B. At step 725, the findings are reported. In an embodiment, a smart aquameter 101 may do this via a communication module 220. As discussed, the reporting may be done in whole or part to any of the devices server 130, mobile device 110, or fixed device 120 or their equivalents.

FIG. 8. illustrates a water management process 800 in an embodiment(s). At step 805 reports associated with the plumbed water system are received. In step 805 a water system is mentioned, but other fluids may be characterized. As discussed, these reports may be received in whole or in part by any of devices smart aquameter 101, server 130, mobile device 110, or fixed device 120 or their equivalents. For example, a smart aquameter 101 may send a report to a third party server utility company. At step 810, the reports may be further processed, formatted, analyzed, or consolidated. For example, various reports of residential consumers sent from smart aquameters 101 may be received at a server 130. The server may perform some crowdsourcing analysis, reformat the reports into a new report, and at step 815 publish the findings. For example, the server 130 may send a report back (publish) on the findings to a specific consumer from step 805.

In other embodiments, the processing modules may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

The described embodiments or any part(s) or function(s) thereof, may be implemented using hardware, software, or a combination thereof, and may be implemented in one or more computer systems or other processing systems. A computer system for performing the operations of the described embodiments and capable of carrying out the functionality described herein may include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the embodiments using other computer systems and/or architectures.

The foregoing description of the preferred embodiments has been presented for purposes of illustration and description. It is not intended to be exhaustive or to limit the embodiments to the precise form or to exemplary embodiments disclosed. Obviously, many modifications and variations will be apparent to practitioners skilled in this art. Similarly, any process steps described might be interchangeable with other steps in order to achieve the same result. The embodiments were chosen and described in order to best explain the principles of the embodiments and its best mode practical application, thereby to enable others skilled in the art to understand the various embodiments and with various modifications as are suited to the particular use or implementation contemplated. It is intended that the scope of the embodiments be defined by the claims appended hereto and their equivalents. Reference to an element in the singular is not intended to mean “one and only one” unless explicitly so stated, but rather means “one or more.” Moreover, no element, component, nor method step in the described disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . .”

In addition, the conjunction “and” when used in the claims is meant to be interpreted as follows: “X, Y and Z” means it can be either X, Y or Z individually, or it can be both X and Y together, both X and Z together, both Y and Z together, or all of X, Y, and Z together.

It should be understood that the figures illustrated in the attachments, which highlight the functionality and advantages of the described embodiments, are presented for example purposes only. The architecture of the described embodiments are sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the described embodiments in any way. It is also to be understood that the steps and processes recited in the claims need not be performed in the order presented.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. A process or method may be implemented with a processor, or similar device, or any combination of hardware and software.

Moreover, a storage medium may represent one or more devices for storing data, including read-only memory (ROM), random access memory (RAM), magnetic disk storage mediums, optical storage mediums, flash memory devices and/or other machine-readable mediums, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices. Moreover, a micro processor, or similar device may have internal or external memory associated with it.

The various features of the embodiments described herein can be implemented in different systems without departing from the embodiments. It should be noted that the foregoing embodiments are merely examples and are not to be construed as limiting the embodiments. The description of the embodiments is intended to be illustrative, and not to limit the scope of the claims. As such, the described teachings can be readily applied to other types of apparatuses and many alternatives, modifications, and variations will be apparent to those skilled in the art.

What is claimed is:

1. A smart aquameter, for water management, comprising:
a power module adapted to power the smart aquameter;
an input-output module adapted to intake water from a plumbed system;
a sensor module adapted to measure water characteristics;
a communication module;
a processor module adapted to send information based on the measured water characteristics via the communication module; and
a memory module coupled to the processor module.

2. The smart aquameter of claim 1, further comprising:
the sensor module comprises a microphone, pressure sensor, or thermo sensor.

3. The smart aquameter of claim 1, further comprising:
the processor adapted to analyze, process, and filter the measured water characteristics.

4. The smart aquameter of claim 1, further comprising:
the processor adapted to analyze the acoustic characteristics of the water, a pipe, or the plumbed system.

5. The smart aquameter of claim 4, further comprising:
the processor adapted to analyze pressure surges caused when a fluid in motion is forced to stop or change direction suddenly.

6. The smart aquameter of claim 1, further comprising:
the processor adapted to analyze the pressure characteristics of the water.

7. The smart aquameter of claim 1, further comprising:
the processor adapted to analyze the temperature characteristics of the water.

8. The smart aquameter of claim 1, further comprising:
the memory module adapted to store the measured, processed, or analyzed water characteristics.

9. The smart aquameter of claim 1, further comprising:
the input-output module adapted to outlet the intake water.

10. The smart aquameter of claim 1, further comprising:
the input-output module adapted to connect to a connector, hose, pipe, water spout, spigot, appliance, or faucet.

11. The smart aquameter of claim 1, further comprising:
the input-output module adapted to connect inline with a pipe or hose.

12. The smart aquameter of claim 1, further comprising:
the input-output module adapted to connect to one side of a pipe or hose.

13. The smart aquameter of claim 1, further comprising:
the communication module adapted to communication on the cellular band, WiFi, and USB.

14. The smart aquameter of claim 1, further comprising:
the communication module adapted to communicate with a server, a mobile device, or a fixed device.

15. The smart aquameter of claim 1, further comprising:
the power module comprises a back up power supply of a battery, a capacitor bank, or induction bank.

16. A smart aquameter, for water management, comprising:
a power module adapted to power the smart aquameter;
an input-output module comprising a sensor module;
a sensor module adapted to measure plumbed system characteristics, the sensor module comprising a microphone;
a communication module;
a processor module adapted to analyze the acoustic characteristics of the plumbed system, adapted to send information based on the measured plumbed system characteristics using the communication module; and
a memory module coupled to the processor module.

17. The smart aquameter of claim 16, further comprising:
the sensor module comprising a pressure sensor and thermo sensor.

18. The smart aquameter of claim 16, further comprising:
the input-output module adapted to intake water from the plumbed system; and
adapted to connect to a water spout, hose, pipe, appliance, spigot, or faucet.

19. A method for water management, comprising:
measuring acoustics of a plumbed water system;
processing the measured acoustics to generate acoustic patterns;
identifying at least one water outlet based on the generated acoustic patterns;
reporting the plumbed water system characteristics, the characteristics comprising the identified at least one water outlet.

20. The method of claim 19, further comprising:
the at least one acoustic sensor comprises a microphone or accelerometer; and
placing the at least one acoustic sensor on the outside of the smart aquameter in contact with a pipe of the plumbed water system.
